(19) United States
(12) Patent Application Publication
(10) Pub. No.: US 2007/0141508 A1
(43) Pub. Date: Jun. 21, 2007

(54) Negative resist composition and method for forming resist pattern

(75) Inventors: Fumitake Kaneko, Kanagawa (JP); Toshikazu Tachikawa, Kanagawa (JP)

Correspondence Address: HARNESS, DICKEY & PIERCE, P.L.C., P.O. BOX 828, BLOOMFIELD HILLS, MI, 48303, US

(73) Assignee: TOKYO OHKA KOGYO CO., LTD., Kanagawa (JP)

(21) Appl. No.: 10/587,438

(22) PCT Filed: Jan. 24, 2005
(86) PCT No.: PCT/JP05/00879

§ 371 Date: Jul. 26, 2006

(30) Foreign Application Priority Data
Jan. 28, 2004 (JP) 2004-019346

(51) Int. Cl. G03C 1/00

(52) U.S. Cl. 430/270.1

(57) ABSTRACT

Disclosed is a negative resist composition which enables to form a resist pattern with improved shape properties by reducing roughness. Also disclosed is a method for forming a resist pattern using such a negative resist composition. The negative resist composition contains at least an alkali-soluble resin, a crosslinking agent which is crosslinked with the alkali-soluble resin by the action of an acid, and an onium salt as a photoacid generator. The anion component of the onium salt is composed of at least a sulfonate having a polycyclic structure.

### TECHNICAL FIELD

The present invention relates to a negative resist composition, more specifically to a negative resist composition which enables the formation of a resist pattern with improved shape properties.

### BACKGROUND ART

Along with the recent tendency to shift towards shorter wavelength light sources, a variety of resists have been investigated in expectation of finding a chemical amplification resist using a photoacid generator particularly from the view point of providing a high resolution and high sensitivity. Generally, chemical amplification resists comprise an alkali-soluble resin (basic resin), a cross-linking agent, and a photoacid generator as their constituents.

As a chemical amplification negative resist, one is generally known in which alkali-soluble resins such as a novolac resin and polyhydroxystyrene are caused to cross-link with amino resins such as melamine resin and urea resin by the action of an acid generated by the radiation exposure such that the irradiated part is altered to become alkali-insoluble while the unexposure part is dissolved by alkali so as to form the negative pattern (for example, Patent document 1: Registered Japanese Patent No. H 8-3635).

There have been hitherto performed various investigations to further improve the performance of chemical amplification negative resists in particular from the view point of using the action of the acid generator as a control factor (for example, Patent document 2: Japanese Unexamined Patent Application Laid-Open No. 2003-121999, etc.).

Patent document 1: Japanese Patent Publication No. H 8-3635.

Patent document 2: Japanese Unexamined Patent Application Laid-Open No. 2003-121999.

### DISCLOSURE OF THE INVENTION

### Problems to be Solved by the Invention

However, in such a chemical amplification negative resist comprising a combination of a conventional acid generator, an alkali-soluble resin, and a cross-linking agent, an acid generated by the acid generator in the resist film is believed to have a high diffusion capacity around the acid generating area, so that the acid action reached areas not exposed to irradiation, resulting in roughness of the line pattern. In addition, when the pattern is formed using a high reflection substrate, this phenomenon becomes especially obvious combined with the reflection of the etching gas and the like due to the high reflection substrate itself. This roughness of line pattern causes dispersion (anisotropy) of the development media such as the etching gas, which is unidirectionally applied to the pattern hereby causing such problems as failure to obtain the lower layer in the desired form after etching. The term “roughness” herein refers to irregularity of the edge of the line pattern.

The present invention has been made in view of the above-described problems. An objective of the present invention is to provide a negative resist composition which enable to the formation of a resist pattern with improved shape properties by reducing the roughness of the resist pattern. Another objective of the present invention is to provide a method of forming a resist pattern using the aforementioned negative resist composition.

### MEANS FOR SOLVING THE PROBLEMS

The inventors actively pursued experimental investigation in the hope of solving the above described conventional problems. As a result, they found that excellent actions and effects can be obtained by using a negative resist composition consisting of at least an alkali-soluble resin, a cross-linking agent which is cross-linked with the above-described alkali-soluble resin by the action of an acid, and an onium salt as a photoacid generator in which the anion component of the onium salt is at least a sulfonate having a polycyclic structure.

Furthermore, the method for forming a resist pattern according to the present invention includes at least the steps of: forming a photoresist layer on the substrate using the above-described negative resist composition, and forming a desired photoresist pattern by applying the radiation exposure and development treatment to this photoresist layer.

### EFFECTS OF THE INVENTION

The present invention can provide a negative resist composition which enables the formation of a resist pattern with improved shape properties by reducing the roughness of the resist pattern. The present invention can also provide a method for forming a resist pattern using the aforementioned negative resist composition.

### BRIEF DESCRIPTION OF THE DRAWINGS

### Preferred Mode for Carrying Out the Invention

Herein below, the present invention will be described in detail. Unless otherwise stated, as the materials, commercial materials can be used.

(I) Photoacid Generator

The term “photoacid generator” refers to a compound generating an acid upon radiation exposure. The photoacid generator included in the negative resist composition of the present invention is an onium salt. A preferable cation component (cationic part) of the onium salt is iodonium salt or sulfonium salt. Among them, iodonium salt is particularly preferable from the view point of an excellent balance between DOF (depth of focus), linearity characteristics, sensitivity and pattern shape common to each of the isolated, L/S and hole patterns.

Preferable examples of this cation component are phenyliodonium salts, sulfonium salts, dimethyl (4-hydroxynaphthyl) sulfonium salts and the like which are substituted with lower alkyl groups such as methyl, ethyl, propyl, n-butyl, and tert-butyl groups; and lower alkoxy groups such as methoxy and ethoxy groups.

A particularly preferable iodonium salt is bis(4-tert-butylphenyl) iodonium slat.

The anion component (anionic part) of the above-described onium salt is composed of at least a sulfonate having a polycyclic structure. A particularly preferable example of the above-described polycyclic structure is at least one type selected from the group consisting of adamantane, tricyclodecane, tetracyclodecane, isobornyl, norbornane, adamantane alcohol, norbornane lactone, or derivatives thereof. A particularly preferable sulfonate having the aforementioned polycyclic structure is the sulfonate represented by the following general formula (1):

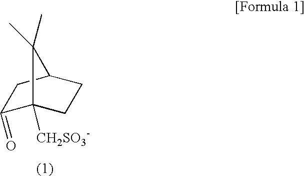

By using the sulfonate having the polycyclic structure described above as an anion component, it is possible to optimize the acid diffusion within the resist membrane and reduce the roughness of the pattern.

Onium salts having the above-described anion component may be used alone or in any combination. They may be used also in combination with onium salts other than those having the above-described anion component. In the present DESCRIPTION, the term “cation component” refers to an ion which takes a cationic form due to a bond cleavage when the onium salt is in a solution state, while the term “anion component” refers to an ion which becomes an anionic form by the bond cleavage when the onium salt is in a solution state.

Such photoacid generators are preferably contained at 0.1 to 10 percent by mass, particularly 0.5 to 5 percent by mass relative to the alkali-soluble resinous ingredient described below.

Furthermore, these photoacid generators may be used alone or in any combination of two or more.

(II) Alkali-Soluble Resin

The alkali-soluble resins contained in the negative resist composition of the present invention are not particularly limited in type so that any desired one can be suitably selected and used among well-known the alkali-soluble resins which have been conventionally used in chemical amplification negative resists. These alkali-soluble resins are exemplified by novolac resin, polyhydroxystyrene, etc.

(III) Cross-Linking Agent

For further increasing the crosslink density and improving resist pattern shape, resolution and anti-dry etching property, the negative resist composition of the present invention contains a cross-linking agent.

Cross-linking agents are not particularly limited in type so that any desired one can be appropriately selected and used among those well-known in the art which have been conventionally used in chemical amplification negative resists. These cross-linking agents can be exemplified by aliphatic cyclic hydrocarbons and oxygen-containing derivatives thereof having either or both of hydroxyl group or hydroxyalkyl group such as 2,3-dihydroxy-5-hydroxymethylnorbornane, 2-hydroxy-5,6-bis(hydroxymethyl)norbornane, cyclohexanedimethanol, 3,4,8 (or 9)-trihydroxytricyclodecane, 2-methyl-2-adamantanol, 1,4-dioxane-2,3-diol, and 1,3,5-trihydroxycyclohexane; and by compounds obtained by reacting amino group-containing compounds such as melamine, acetoguanamine, benzoguanamine, urea, ethylene urea, and glycoluril with formaldehyde or together with formaldehyde and lower alcohol so as to replace the hydrogen atom of the amino group by a hydroxymethyl group or lower alkoxymethyl group; more specifically by hexamethoxymetylmelamine, bismethoxymethylurea, bismethoxymethylbismethoxyethylene-urea, tetramethoxymethylglycoluril, and tetrabutoxymethyl-glycoluril; and the most preferable are glycoluril cross-linking agents, in particular tetramethoxymethylglycoluril. In the present invention, those cross-linking agents may be used alone or in any combination of two or more.

These cross-linking agents are contained preferably at 3 to 30 percent by mass, particularly preferably 5 to 15 percent by mass relative to the above-described alkali-soluble resinous ingredient.

(IV) Acidic Compounds and/or Basic Compounds

The negative resist composition of the present invention may include an acidic compound and/or a basic compound for adjusting the sensitivity thereof. The appropriate use of these acidic compounds and/or basic compounds enables the optimization of the diffusion capacity of the acid derived from a specifically structured onium salt, which is the most important characteristic of the present invention. Acidic compounds and/or basic compounds are not particularly limited in type such that any desired compound may be appropriately selected for use among well-known acidic compounds and/or basic compounds which have been conventionally used in chemical amplification negative resists. Examples of these acidic compounds and/or basic compounds include those as described below.

Acidic compounds are exemplified by salicylic acid, phosphonic acid, phenylphosphonic acid, benzoic acid, valeric acid, etc.

Basic compounds are exemplified by C₂ to 5 monoalkanolamine, dialkanolamine, trialkanolamine, monoalkylamine, dialkylamine, and trialkylamine, furthermore, cyclohexylamine, etc.

In the present invention, the above-described acidic compounds and/or basic compounds may be used alone or in any combination of two or more.

These acidic compounds and/or basic compounds are contained preferably at 0.05 to 10 percent by mass, particularly preferably 0.1 to 1 percent by mass relative to the above-described alkali-soluble resinous ingredient.

The negative resist composition of the present invention is preferably used in a solution form in which the above-described ingredients are dissolved in solvents. Examples of such solvents include ketones such as acetone, methyl ethyl ketone, cyclohexanone, methyl isoamyl ketone, and 2-heptanone; polyalcohols and derivatives thereof such as ethylene glycol, ethylene glycol monoacetate, diethylene glycol, diethylene glycol monoacetate, propylene glycol, propylene glycol monoacetate, dipropylene glycol or dipropylene glycol monoacetate, or monometyl ether, monoethyl ether, monopropyl ether, monobutyl ether or monophenyl ether thereof; cyclic ethers such as dioxane; esters such as methyl lactate, ethyl lactate, methyl acetate, ethyl acetate, butyl acetate, methyl pyruvate, ethyl pyruvate, methyl methoxypyruvate, and ethyl ethoxypyruvate; and amide solvents such as N,N-dimethylformamide, N,N-dimethylacetamide, and N-methyl-2-pyroridone. A solvent consisting of propylene glycol monomethyl ether acetate:propylene glycol monomethyl ether=3:7 is preferable. These solvents may be used alone or in any combination of two or more. Furthermore, the above-described solvents may be used as a mixed solvent with water.

The negative resist composition of the present invention is excellent in its solubility in the above-described solvents. Furthermore, the storage stability thereof can be improved by dissolving it in the above-described solvents.

To the negative resist composition of the present invention may be further added as desired commonly used mixable additives such as supplementary resin, plasticizer, stabilizer, coloring agent, and surfactant which are commonly used to improve the resist membrane performance.

The negative resist of the present invention has a high transparency to ArF excimer laser beams and KrF excimer laser beams, furthermore an excellent alkali-solubility and a high resolution. In addition, it has stability over time equal to or greater than that of conventional negative resists.

The solid concentration in the negative resist composition of the present invention is preferably set at 1 to 20 percent by mass, particularly preferably 2 to 18 percent by mass.

As a method of using the negative resist composition of the present invention, it is possible to use the method of forming the resist pattern according to the conventional photoresist technique. For preferable processing, a solution of the resist composition is first applied to a substrate with a spinner and the like, dried to form a photosensitive layer, which is then heated by radiation exposure with ArF excimer laser beams and such using a reduced projection exposure device via a desired mask pattern. Subsequently, the exposed substrate is treated for development using a developer such as an alkaline aqueous solution such as a 0.01 to 10 percent by mass tetramethyl ammonium hydroxide aqueous solution. With this forming method, an image faithful to the mask pattern can be obtained.

Substrates to which the negative resist composition of the present invention is applied are not particularly limited in type, and any of various substrates such as silicone wafers, silicone wafers provided with an organic or inorganic reflection preventive membrane, and glass substrates to which negative resists have been conventionally applied may be used.

### EXAMPLES

Herein below, the present invention will be further described in detail with reference to Examples, which are merely for explaining the present invention in more detail, but not to be construed as limiting this invention.

### Example 1

A resist pattern was formed using the negative resist composition of the present invention. Specifically, first a styrene-hydroxystyrene copolymer (polymerization ratio 20:80, molecular weight 3,000) as an alkali-soluble resinous ingredient; an onium salt comprising bis(4-t-butylphenyl)iodonium cation and an anion represented by the following general formula (1) as an acid generator (1.0 percent by mass), phenylsulfonic acid/triisopropanol=0.21/0.25 as an acidic compound and/or a basic compound (0.46 percent by mass), and MX-70 (Sanwa Chemicals) as a cross-linking agent (10 percent) (these numerical percentages in parentheses all represent values relative to the resin mass) are dissolved in the solvent (propylene glycol monomethylether/propyleneglycol monomethylether acetate=7/3). The resulting mixture was adjusted to 7.8 percent by mass for the total solid concentration thereof, applied to the reflection-preventive membrane using a spinner, and dried by baking on a hot plate at 90° C. for 60 seconds to form a resist layer of 450 nm in membrane thickness on the substrate.

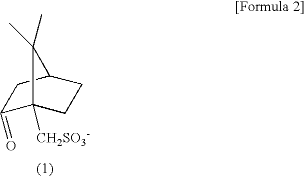

Next, the coated substrate was irradiated with (exposed to) the pattern beam using an ArF eximer laser (wavelength 193 nm) with an NSR-S302 exposure apparatus (Nikon) in line via the mask pattern.

Subsequently, the exposed substrate was subjected to PEB treatment under conditions of 110° C. for 60 seconds. Development was performed by treating the substrate at 23° C. with a 2.38 percent by mass TMAH aqueous solution for 30 seconds followed by post-baking at 100° C. for 60 seconds.

As a result of observation (inspection) of the resist pattern with a scanning electron microscope (SEM), it was found that an excellent resist pattern of 280 nm L/S was obtained with no roughness being observed. The resist pattern was also excellent in its lithographic characteristics such as the resolution.

### Comparative Example 1

Except for replacing the anion used as an acid generator in Example 1 by the ion comprising CF₃SO₃⁻, the resist pattern was formed similarly to Example 1.

As a result, a conspicuous roughness was observed compared to Example 1.

As explained above, the negative resist composition of the present invention is characterized in comprising at least an alkali-soluble resin, a cross-linking agent which is cross-linked with the alkali-soluble resin by the action of an acid, and an onium salt as a photoacid generator, in which the anion component of the onium salt is at least a sulfonate having a polycyclic structure. With such a composition, the present invention can obtain the effects described below.

With the present invention characterized by the above-described composition, roughness can be reduced. As a result, no anisotropy of etching gas and such is caused so as to enable the formation of a resist pattern with improved shape properties. The present invention is effective in using a high reflection substrate and in an implantation process or the like in particular.

The method of forming the resist pattern of the present invention comprises at least the steps of: forming a photoresist layer on the substrate using the aforementioned negative resist composition, and forming the desired photoresist pattern by applying the exposure and development processes to this photoresist layer.

With the present invention having the above-described composition, it is possible to obtain a good resist pattern having a high resolution.

### INDUSTRIAL APPLICABILITY

As described above, the negative resist composition of the present invention enables the formation of a resist pattern with improved shape properties by reducing roughness so as to be useful in a semiconductor-manufacturing process.

1. A negative resist composition comprising at least an alkali-soluble resin, a cross-linking agent which is cross-linked with the alkali-soluble resin by the action of an acid, and an onium salt as a photoacid generator, in which the anion component of the onium salt is a sulfonate having a polycyclic structure.

2. The negative resist composition according to claim 1 further comprising an acidic compound and/or a basic compound.

3. The negative resist composition according to claim 1, wherein the polycyclic structure is at least one selected from a group consisting of adamantane, tricyclodecane, tetracyclodecane, isobornyl, norbornane, adamantane alcohol, norbornane lactone, and derivatives thereof.

4. The resist composition according to claim 1, wherein the anion component of the onium salt is a sulfonate represented by the following general formula (1).

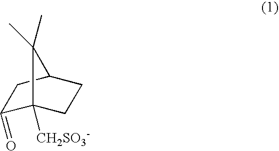

5. The negative resist composition according to claim 1, wherein the cation component of the onium salt is an iodonium salt.

6. A method for forming a resist pattern comprising the steps of: forming at least a photoresist layer on a substrate using the negative resist composition according to claim 1, and forming the desired photoresist pattern by applying exposure and development processes to the photoresist layer.

7. The negative resist composition according to claim 2, wherein the polycyclic structure is at least one selected from a group consisting of adamantane, tricyclodecane, tetracyclodecane, isobornyl, norbornane, adamantane alcohol, norbornane lactone, and derivatives thereof.
